(19) United States
(12) Patent Application Publication
(10) Pub. No.: US 2008/0101884 A1
(43) Pub. Date: May 1, 2008

(54) TRUCK BED CARGO ORGANIZER AND METHODS

(76) Inventor: Charles Schmeichel, Jamestown, ND (US)

Correspondence Address: Moore & Hansen, PLLP, Suite 4850, 225 South Sixth Street, Minneapolis, MN, 55402, US

(21) Appl. No.: 11/876,480

(22) Filed: Oct. 22, 2007

Related U.S. Application Data
(60) Provisional application No. 60/863,169, filed on Oct. 27, 2006.

(51) Int. Cl. B60P 7/08

(52) U.S. Cl. 410/121

(57) ABSTRACT

Devices and systems for providing customizable and adjustable storage compartments in the cargo box of pickup trucks. One device includes a separation member having a first region for securing to a truck compartment side via an attachment panel and a second region. Preferably, the second region is secured to the wheel well with a fastener. The separation member further includes an intermediate region between the first and second regions which can include curved and/or sharply bent regions to traverse the wheel well width distance of the storage compartment. Threaded fasteners, adhesives, hook and loop fasteners, adhesive materials and the like can be used to secure the separation member to the wheel well and the attachment panel and the attachment panel to the cargo box inside side wall. Methods of using the same are also disclosed.

### FIELD OF THE INVENTION

The present invention is related to cargo organizers for pickup trucks; more specifically, cargo organizers that are secured to a portion of a pickup truck cargo box or truck bed to provide a compartment for organizing cargo in the bed of the pickup truck.

### BACKGROUND OF THE DISCLOSURE

Pickup trucks are becoming ever more popular as a vehicle of choice in the United States and elsewhere. They have been used for many years as work vehicles for carrying required equipment, transporting materials and/or traversing rugged terrain, often primarily when this has been a part of the users daily routine.

As time has passed, however, and more and more people participate in a broader variety of activities in their time away from work, some of which require them to transport equipment and/or materials that are most easily transported in a truck bed or cargo box of a pickup truck, pickup truck sales and use have increased. This has led, in part, to the even greater popularity of pickup trucks as the vehicle of choice in many families, both rural and urban. This has been especially so as more families have found a need to have more than one vehicle, which allows them to select vehicles having a range of capabilities.

The present invention provides improvements which address limitations associated with the prior art.

### SUMMARY OF THE INVENTION

The present invention relates to a truck bed cargo organizer for a pickup truck cargo compartment, wherein the truck compartment includes two opposing side walls, a front wall, a tailgate, each of the side walls being adjacent to a wheel well. The preferred cargo organizer comprises a separation member having a first region, a second region and an intermediate region connecting the first and second regions. The preferred cargo organizer additionally includes an attachment panel that can operatively secure the first region to one of the truck compartment side walls. The second region extends generally perpendicular to the first region towards the front wall when the first region is attached to the attachment panel and the attachment panel is secured to one of the truck compartment side walls. The present invention is preferably adjustable in that the attachment panel can be connected to different points on the first region to adjust the distance between the second region and the respective side wall. Preferably, the attachment panel further includes at least one slot through which the first region and the attachment panel can be connected with a nut and bolt fastener, the slot permitting the first region and the attachment panel to be adjustably connected with the nut and bolt fastener. The second region can also be attached to the cargo compartment with a fastener. In preferred embodiments, the second region is fastened to the wheel well adjacent to the respective side wall to which the attachment panel is connected.

The present invention further includes methods of dividing a pickup truck cargo boxes with at least one cargo organizer of the present invention. One preferred method comprises the steps of providing a cargo organizer including a separation member having a first region, a second region and an intermediate region connecting the first and second regions and an attachment panel, the cargo organizer further includes a first fastener connecting the first region to the attachment panel. Preferably, the attachment panel and the first member are adjustably connected by, for example, sliding at least one bolt through respective slots in the attachment panel and the first member and securing corresponding nuts on the bolts. Then, the attachment panel can be operatively secured to one cargo box side wall with a second fastener and then the first fastener can be adjusted until the second region is positioned at a desired distance from the respective side wall. In preferred embodiments, a third fastener will be provided and the second region will be attached to the cargo box, preferably, the wheel well adjacent to the respective side wall.

These and other objectives and advantages of the present invention will appear more fully from the following description, made in conjunction with the accompanying drawings, wherein like reference characters refer to the same or similar parts throughout the several views. And, although the disclosure hereof is detailed and exact to enable those skilled in the art to practice the present invention, the physical embodiments disclosed herein merely exemplify the invention, which may be embodied in other specific structures. While the preferred embodiment has been described, the details may be changed without departing from either the spirit or the scope of the present invention, which is defined by the broad general terms recited in the claims appended hereto.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include corresponding parts;

FIG. 1 is a fragmentary, perspective view of a pickup truck cargo box 20 having an embodiment of a cargo box divider or truck bed cargo organizer 40 according to the present invention installed;

FIG. 2 is another fragmentary, perspective of the pickup truck cargo box 20 of FIG. 1 illustrating the cargo box divider or truck bed cargo organizer 40 having an intermediate region 46 including slots 62 therethrough, allowing for size adjustment for various wheel well widths;

FIG. 3 is a top view of the pickup truck cargo box 20 of FIG. 1, having two truck bed cargo organizers 40 installed therein, with a first 4 by 8′ sheet of plywood or drywall 74 carried in the pickup truck cargo box 20 and a second sheet 76 about to be slid into the pickup truck cargo box 20 between the two guiding truck bed cargo organizers 40;

FIG. 4 is an end, rear view of the pickup truck cargo box 20 of FIG. 3, having the sheets of plywood or sheetrock 74, 76 disposed between the two cargo box dividers or truck bed cargo organizers 40;

FIG. 5 is a fragmentary, top view of the cargo box divider 40 of FIG. 1, also illustrating alternate embodiments having a round or, alternatively, chamfered intermediate region 46, and/or having an extending first region 43 for securing a rear portion 85 of the divider 40 to the pickup truck cargo box rear inside wall (not shown); and

FIG. 6 is a top, fragmentary view of another embodiment of divider 40 having the intermediate region 46 formed of overlapping pieces, having either a smoothly curved or a sharply bent intermediate region 46, and hook and loop fastener 106, 108 and 112, 115 for securing the flat region 104 and flat portion 110 to each other and for securing the forward, second region to the wheel well 28, respectively.

### DETAILED DESCRIPTION OF THE PREFERRED EMBODIMENTS

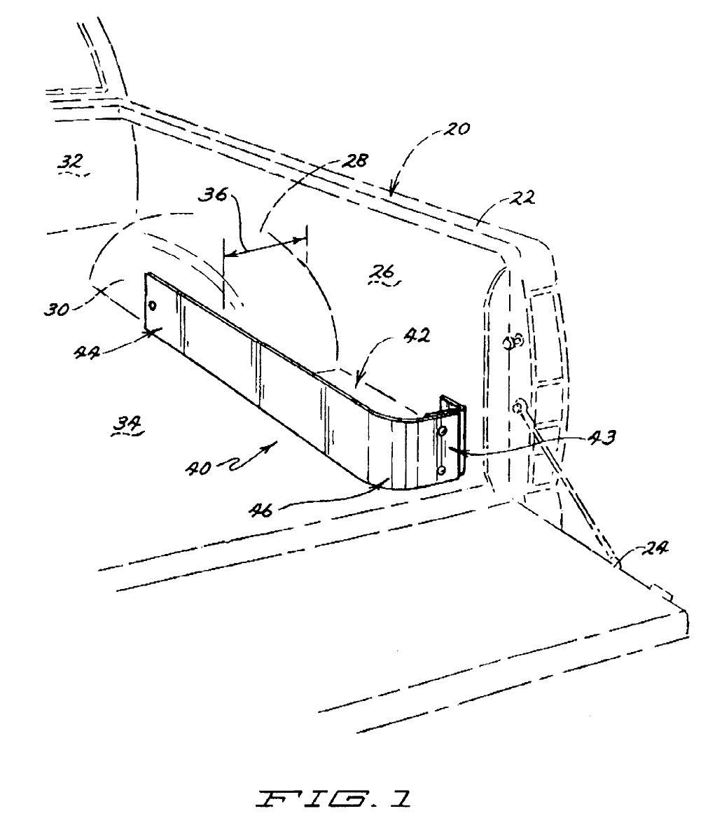

FIG. 1 is a perspective view illustrating a pickup truck cargo box 20 having a side wall 22, an inside side wall 26, a front wall 32, a floor 34, and a tailgate 24. FIG. 1 also illustrates a wheel well 28 having a wheel well width 36 and an inside wall 30. A cargo box divider or organizer 40 is also illustrated, having a first region 43, a second region 44 and an intermediate region 46. The divider 40 is arranged and configured to form at least one compartment 42 between the divider 40 and inside wall 26, preferably having a width 36 generally equal to the wheel well width 36. The preferred divider 40 is further customizable in that it can be adjustable to fit a variety of wheel well widths.

In alternative embodiments, the second region 44 can be configured to extend past the wheel well 28 and towards the front wall 32 in order to create a second compartment (not shown). In this embodiment, the second region 44 can connect to the front wall 32 or the side wall 26 with fasteners as described below and is adjustable as described above. The second region 44 can also be secured to the wheel well 28 to reinforce the strength of the divider 40.

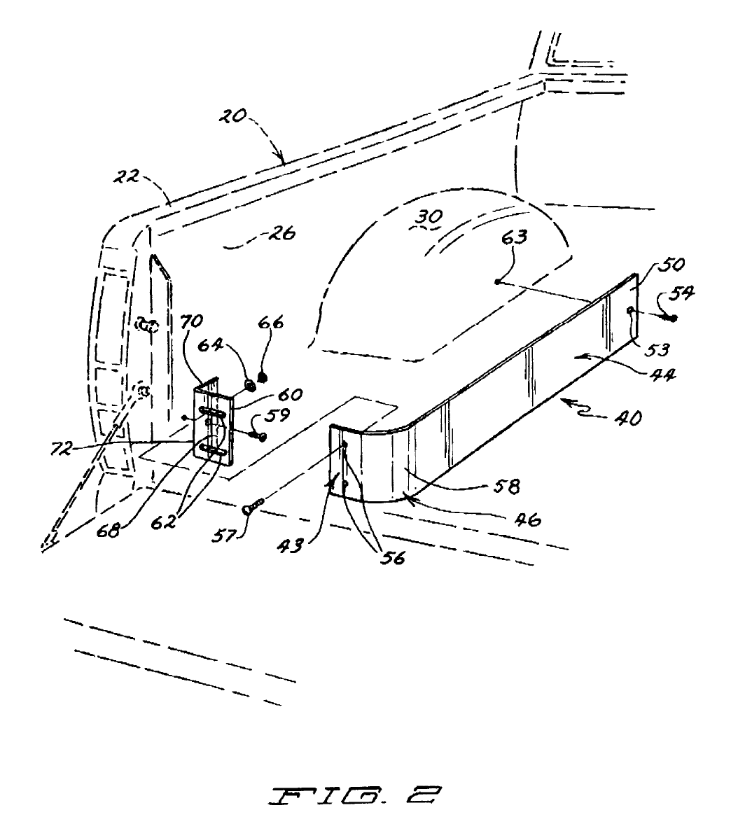

Now also referring to FIG. 2, FIG. 2 is a further perspective view illustrating a different portion of the pickup truck cargo box 20, showing the divider 40 in an exploded view. In this embodiment, the wheel well inside wall 30 has an aperture 63 for receiving a threaded fastener 54 extending through an aperture 52 in a first flat portion 44 of the divider 40. The first flat portion 44 is located generally in the second region 44 of the divider 40. In this embodiment, the intermediate region 46 includes a curve 58 which extends to the first region 43 having the aperture 56 for receiving a threaded fastener 57, such as a bolt or a screw. A second piece 60 has slots 62 extending generally horizontal along its width. The second piece 60 further includes a first portion 68 substantially parallel to the rear or tailgate 24 and a second portion 70 separated by a sharp bend 72 from the rear facing surface 68. The threaded fastener 57 extends through the aperture 56 and the slot 62 to be received by a washer 64 and a threaded nut 66. Additionally, in preferred embodiments, another threaded fastener 59 can be used for securing the second piece 60 to the inside wall 26. As shown in FIG. 2, the slots 62 allow first region 43 to variably position the flat portion 44 from the inside wall 26. In alternate embodiments, the intermediate region 46 can be formed of two distinct overlapping pieces (not shown). In further alternate embodiments, the first, second and intermediate regions 43, 44 and 46 can be abutting (not shown).

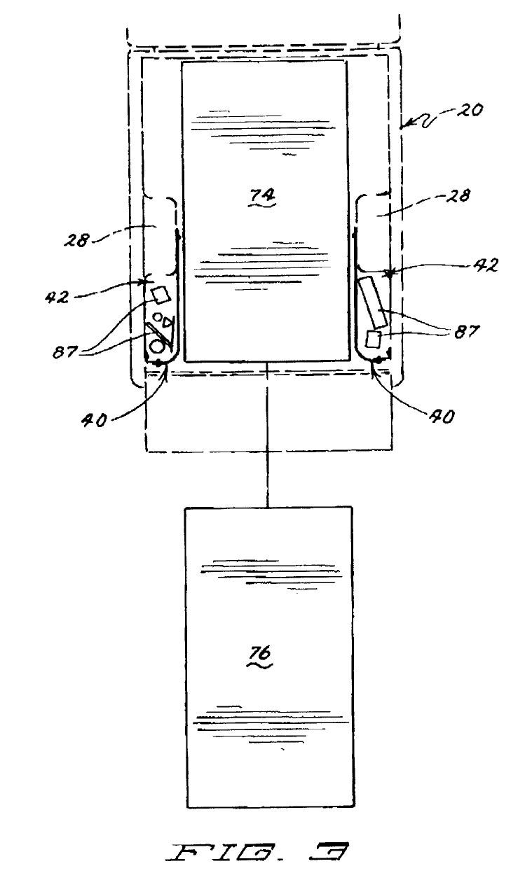

FIG. 3 is a top view of the pickup truck cargo box 20 of FIG. 1. The divider 40 is shown having several items 87 within compartment 42 behind the wheel well 28. As shown, two opposing cargo box dividers 40 are preferably configured and arranged to leave a substantially large portion of the cargo box 20 available for the receipt of 48 inch wide or less pieces of sheetrock, plywood, or the like. Sheetrock piece 74 has been loaded into the cargo box, while sheetrock piece 76 is yet to be slid into the cargo box over the previously loaded sheetrock piece 74. The rounded intermediate region 46 provides a gentler guide region for inserting sheetrock pieces 74 and 76 when inserted slightly off center. The rounded intermediate portion 46 guides the sheetrock pieces 74, 76 into the center of pickup truck cargo box 20.

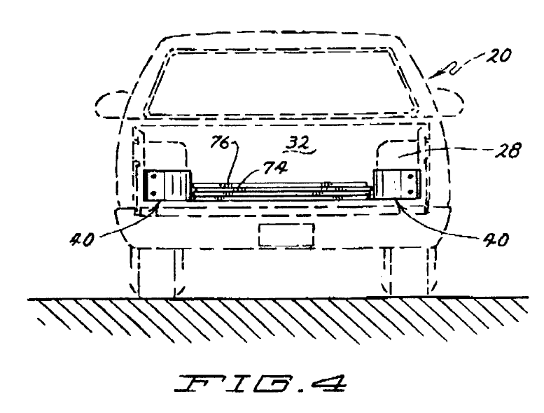

Referring, in addition, now to FIG. 4, FIG. 4 illustrates the pickup truck cargo box 20, from the tailgate 24 end, having sheet rock pieces 74 and 76 slid forward towards the front inside wall 32. In this embodiment, the dividers 40 are positioned such that standard 48 inch wide pieces of plywood, sheetrock and the like fit within the cargo box 20 and will be generally prevented from lateral movement while being transported in the cargo box 20.

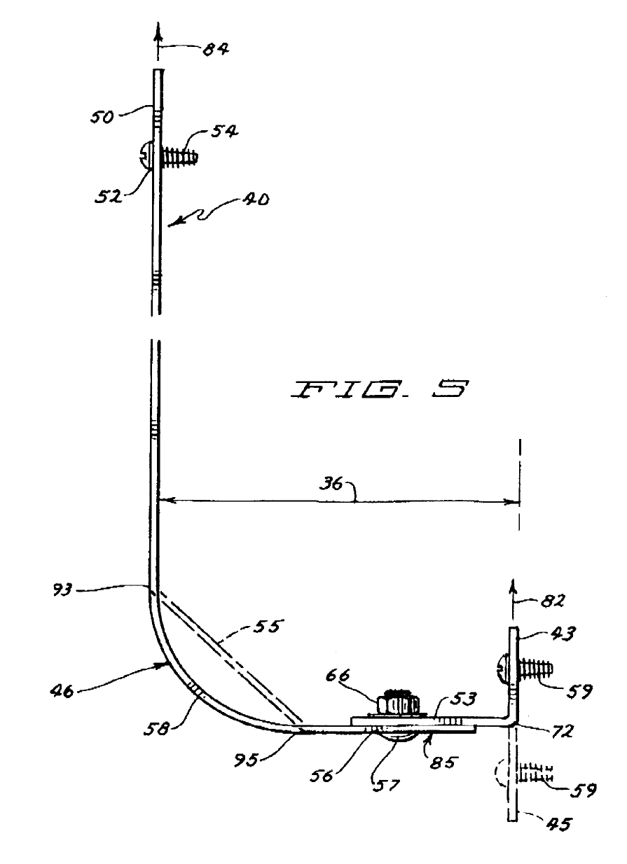

Now also referring to FIG. 5, which illustrates a top view of the divider 40. In this embodiment of the divider 40, which extends from the front wall 32 to the rear or tailgate 24, the divider 40 includes a second region 44 extending generally in a first direction 84 and having a threaded fastener 54 extending through an aperture 52. The second region 44 extends rearwardly and the intermediate region 46 has a curved region 58 (as shown in solid lines), which then extends to the first region 43 having at least one aperture 56 arranged and configured to receive a bolt 57. The bolt 57 extends through another aperture (not shown) in a separate overlapping piece 53 and can be received within threaded nut 66. In this embodiment, the first region 43 has a sharp bend 72 to receive a threaded fastener or screw 59 through an aperture of the second, rear, flat portion 85. The flat portion 85 can be seen to extend forwardly, as indicated by directional arrow 82. It is noted that, preferably, directions 82 and 84 are substantially the same direction, generally parallel with each other.

FIG. 5 also illustrates an alternate second, rear flat region 45, which can also be used with a threaded fastener 59 that is secured to the inside side wall 26 of the pickup truck cargo box 20 (see also, FIG. 1). Rotating the threaded fastener 59 into the side wall can be more easily accomplished by securing the flat regions 85, 45 before the first region 43 of the divider 40 is connected to the overlapping piece 53.

FIG. 5 also shows that the intermediate region 46 between the second region 44 and first region 43, can alternatively be configured as a chamfered or sharply bent angled region 55 (shown in dashed lines), which can be fashioned by forming two sharp angles as indicated at 93 and 95. Intermediate regions that are curved or multiple angled are preferred over a right angled shape as the intermediate region can serve as a guide to direct articles, such as plywood sheets, into the truck cargo compartment. A rounded intermediate region is preferred also because manufacturing only requires making one bend rather than two.

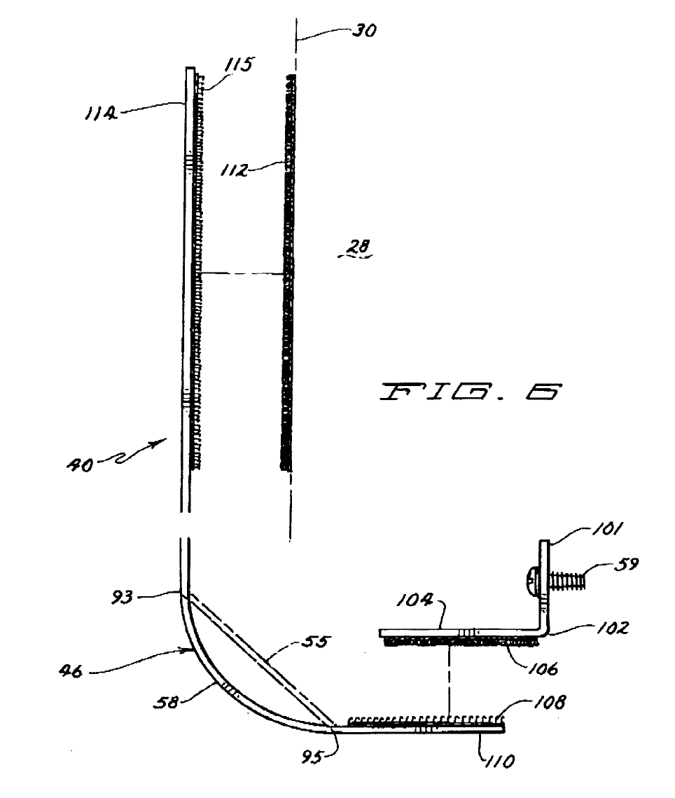

Now also referring now to FIG. 6, which illustrates yet another embodiment of the divider 40 for securing to the inside wheel well wall 30 of a pickup truck cargo box 20. This alternate embodiment of the divider 40 includes hook or loop fasteners 112 secured to the inner surface of wheel well 28. An angled fastener 101 can also be used to receive a threaded fastener 59 through the angled fastener 101 and into the inner side wall 26 (see also FIG. 1). The angled fastener 101 includes sharp bend 102 perpendicular to the inner side wall 26 and a flat region 104 that includes either hook or loop fastener 106 applied thereon. Another region of corresponding hook or loop fastening material 108 extends along the inside surface of a flat portion 110 and can be adjustably secured to the hook and loop fastener 106. In one embodiment, the intermediate region 46 includes a smooth curve 58, as discussed above. The intermediate region 46 also can contain sharp, discontinuous bends 93 and 95 as of the embodiment shown in FIG. 5, forming an angle inner surface 55 instead of a smooth curve 58. The divider 40 extends forward to a second, forward flat region 114. In this embodiment, hook or loop fastener 112 is used for securing the second, forward flat region 114 to the hook or loop fastener 115 on the inside of the wheel well 26 such that the divider 40 is removeably secured to the wheel well 26. It will be appreciated that if the hook or loop fasteners 112, 106 are hooks then the hook and loop fasteners 115, 108 should be loops, and vice versa.

As can be seen from inspection of the figures, the divider can be formed as a single continuous piece or as two or more distinct pieces secured together. Separate pieces can provide the advantage of allowing the second portion to be secured securely to the truck cargo box inside wall, followed by joining the second portion to the first region. This can allow for more variability in wheel well width by adjusting the amount of overlap between the first portion and the attachment panel.

The intermediate region can be formed using either smooth bends or sharp bends/angles such that it has a shape such as curved, multiple angle, right angled, generally linear, U-shaped and the like. Securing the first and second regions to the wheel well inside portion or truck inside walls can be accomplished using hook and loop fasteners, adhesives, threaded fasteners, or any other suitable fastening mechanism, which will be apparent to those skilled in the art in view of this disclosure.

The divider can be made using many different materials and methods and combinations of these. The divider generally can be made of metal, plastic, composite, fiberglass and the like. In some embodiments, the divider is generally formed of stainless steel or other alloy steel, which can be painted or coated. In alternate embodiments, the divider generally can be formed of open material, such as expanded metal or a plastic wall included numerous large apertures through the wall. Alternate dividers can additionally have wider bottoms than tops, while other embodiments can be symmetrical, such that the same part can be flipped over and used on the opposite side of the cargo box.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A truck bed cargo organizer for a pickup truck cargo compartment, wherein the cargo compartment includes two opposing side walls, a front wall and a tailgate, each of the side walls being adjacent to a wheel well, the cargo organizer comprising:
a separation member having a first region, a second region and an intermediate region connecting the first and second regions; and
an attachment panel that can operatively secure the first region to the cargo compartment; wherein the attachment panel can be adjustably secured to the first region to operatively secure the first region to the cargo compartment; wherein the second region extends generally perpendicular to the first region towards the front wall when the first region is attached to the attachment panel and the attachment panel is secured to the cargo compartment.

2. The cargo organizer of claim 1, wherein the second region can be attached to the truck compartment.

3. The cargo organizer of claim 2, wherein the second region can be attached to the wheel well adjacent to the side wall.

4. The cargo organizer of claim 2, further comprising a fastener that can be used to attach the second region to the truck compartment, wherein the fastener is selected from the group consisting of hook and loop fasteners, adhesives, threaded fasteners and adhesive materials.

5. The cargo organizer of claim 1, wherein the separation member further includes at least one slot through which the first region and the attachment panel can be connected with a nut and bolt fastener, the slot permitting the first region and the attachment panel to be adjustably connected by the nut and bolt fastener.

6. The cargo organizer of claim 1, wherein the attachment panel can operatively secure the first region to one of the side walls with a fastener selected form the group consisting of hook and loop fasteners, adhesives, threaded fasteners and adhesive materials.

7. The cargo organizer of claim 1, wherein the intermediate region has a shape selected from the group consisting of curved, multiple angle, right angled, generally linear and U-shaped.

8. A truck bed cargo organizer for attachment to a pickup truck cargo compartment, the cargo compartment including two opposing side walls, a front wall and a tailgate, each of the side walls being adjacent to a wheel well, the cargo organizer comprising:
a separation member having a first region, a second region and an intermediate region connecting the first and second regions; and
an attachment panel that can operatively secure the first region to one of the cargo compartment side walls; wherein the attachment panel can be adjustably connected to the first region to operatively secure the first region to the side wall; wherein the second region extends generally perpendicular to the first region towards the front wall of the truck compartment when the truck bed organizer is operatively installed.

9. The truck bed cargo organizer for attachment to a pickup truck cargo compartment of claim 8, wherein the second region can be attached to the truck compartment.

10. The truck bed cargo organizer for attachment to a pickup truck cargo compartment of claim 9, wherein the second region can be attached to the wheel well adjacent to the side wall.

11. The truck bed cargo organizer for attachment to a pickup truck cargo compartment of claim 9, wherein the second region is attached with a fastener selected from the group consisting of hook and loop fasteners, adhesives, threaded fasteners and adhesive materials.

12. The truck bed cargo organizer for attachment to a pickup truck cargo compartment of claim 8, wherein the cargo organizer further includes at least one slot through which the first region and the attachment panel can be connected with a nut and bolt fastener, the slot permitting the first region and the attachment panel to be adjustably connected by the nut and bolt fastener.

13. The truck bed cargo organizer for attachment to a pickup truck cargo compartment of claim 8, wherein the attachment panel can operatively secure the first region to one of the truck sides with a fastener selected form the group consisting of hook and loop fasteners, threaded fasteners and adhesive materials.

14. The truck bed cargo organizer for attachment to a pickup truck cargo compartment of claim 8, wherein the intermediate region has a shape selected from the group consisting of curved, multiple angle, right angled, generally linear and U-shaped.

15. A method of dividing a pickup truck compartment, wherein the truck compartment comprises two opposing side walls, a front wall, a tail gate and a wheel well, the method comprising the steps of:
providing a cargo organizer including a separation member having a first region, a second region and an intermediate region connecting the first and second regions; and an attachment panel, the cargo organizer further including a first fastener connecting the first region to the attachment panel;
operatively securing the attachment panel to a truck compartment side wall with a second fastener; and
adjusting the separation member until the second region is positioned at a desired distance from the truck compartment side wall.

16. The method of claim 15, further comprising the step of providing a third fastener and fastening the second region to the truck compartment.

17. The method of claim 16, wherein the second region is fastened to the wheel well adjacent to the truck compartment side wall.

18. The method of claims 15, wherein the second and third fasteners are each selected from the group consisting of hook and loop fasteners, threaded fasteners and adhesive materials.

19. The method of claim 15, wherein the first fastener is selected form the group consisting of hook and loop fasteners and threaded fasteners.

20. The method of claim 15, wherein the cargo organizer further includes at least one slot through which the first region and the attachment panel can be adjustably connected with the first fastener, wherein the first fastener is a nut and bolt fastener.

21. The method of claim 15, further comprising the step of securing the adjusted separation member at the desired distance.
